(19) United States
(12) Patent Application Publication
(10) Pub. No.: US 2020/0197787 A1
(43) Pub. Date: Jun. 25, 2020

(54) HORSE RACING CASINO DERBY

(71) Applicant: Harry Jackson, Binghamton, NY (US)

(72) Inventor: Harry Jackson, Binghamton, NY (US)

(21) Appl. No.: 16/226,623

(22) Filed: Dec. 19, 2018

(51) Int. Cl. A63F 3/00; G07F 17/32

(52) U.S. Cl. CPC A63F 3/00157; G07F 17/32

(57) ABSTRACT

A casino game having a horse-racing theme. The casino game encompasses a number of playable races. A horseshoe playing surface is provided, which has a plurality of horse positions and a roulette-styled betting area inscribed thereon.

### RELATED PATENT APPLICATION

The present application is related to co-pending U.S. provisional patent application for HORSE RACING CASINO GAME, application No. 62/608,235, filed Dec. 20, 2017, and hereby incorporates the teaching therein by reference.

### FIELD OF THE INVENTION

The present invention pertains to casino games and, more particularly, to a casino game including provision for players to bet on horses in a simulated horserace, playing position markers representing racing horses, and means for wagering.

### BACKGROUND OF THE INVENTION

The competitive racing of horses is one of humankind's most ancient sports, having its origins among the prehistoric nomadic tribesmen of Central Asia who first domesticated the horse some 6,000 years ago. For thousands of years, horse racing flourished as the sport of kings and nobility.

Horse racing is the second most widely attended U.S. spectator sport, after baseball. Horse racing is also a major professional sport in Canada, Great Britain, Ireland, Western Europe, Australia, New Zealand, South Africa, and South America.

By the time humans began to keep written records, horse racing was an organized sport in all major civilizations from Central Asia to the Mediterranean. Both chariot and mounted horse racing were events in the ancient Greek Olympics, and the sport was widely popular in the Roman Empire.

Horse racing began to become a professional sport during the reign of Queen Anne in the early 18^{th} century, when match racing gave way to races involving several horses on which the spectators wagered. Racecourses were built all over England, offering increasingly large purses to attract the best horses. These purses in turn made breeding and owning horses for racing profitable.

British settlers brought horses and horse racing to the New World, with the first racetrack laid out on Long Island in the 17^{th} century. Gambling on racehorses grew significantly over time. By 1890, 314 tracks were operating across the United States.

Thoroughbred tracks now exist in half of the United States. Public interest in the sport focuses primarily on major thoroughbred races such as the American Triple Crown and the Breeder's Cup races, which offer purses of up to $1,000,000.

Wagering on the outcome of horse races is a substantial factor in explaining why horse racing has survived as a major professional sport. In other words, one of the reasons for the popularity of horse racing is the provision generally made for betting or wagering on the outcome of such races.

At all tracks, bettors may wager on a horse to win (finish first), place (finish first or second), or show (finish first, second, or third). Other popular wagers are the daily double (picking the winners of two consecutive races), exactas (picking the first and second horses in order), quinellas (picking the first and second horses in either order), and the pick six (picking the winners of six consecutive races). As horse racing and wagering on such races have become more popular, various refinements of the rules of betting (exactas, odds, etc.) have evolved.

It is only logical that major gambling establishments, such as casinos, would have a connection to horse racing. In fact, many casinos are associated with racetracks. Thus, there is a great following in the casino industry of placing bets on horses.

### DESCRIPTION OF RELATED ART

U.S. Pat. No. 3,690,666 issued to Seitz on Sep. 12, 1972 for HORSE RACING BOARD GAME APPARATUS describes a horse racing game including a game board inscribed with a simulated racetrack, and a plurality of cards inscribed with various groups of numbers which indicate horse performance, a particular horse's rating, key numbers, and index numbers. A race action board has various tables and charts which are used, in combination with the horse performance cards, to determine the amount each marker representing a horse is to be moved along the simulated racetrack. A random number selector is used to determine the key numbers and various finder numbers which are used with a plurality of finder tables which are, in turn, used to determine the track condition, race time, odds for each horse, etc. A race charting sheet is used to record all pertinent data during the preparation for and running of each race.

U.S. Pat. No. 4,060,246 issued to Ward on Nov. 29, 1977 for HORSE-RACE-SIMULATING PARLOR OR CASINO GAME OF PURE CHANCE describes a horse-race-simulating parlor, casino or the like game of pure chance, comprising a combination of a pair of dice which can be rolled to eleven numbers, from 2 to 12, and a play-board having thereon eleven play-numbers, from 2 through 12, representing eleven horses, and a finish-number which is the lowest common multiple of the numbers 1, 2, 3, 4, 5, and 6, representing ways in which said eleven horse-numbers can be rolled by the or is a multiple of such lowest-common-multiple, and having a chance-equalizing number for each play-number or horse-number, which chance-equalizing number is the lowest-common-multiple divided by the number of ways the play-number can be rolled by the dice.

U.S. Pat. No. 5,226,655 issued to Rickabaugh on Jul. 19, 1993 for APPARATUS AND METHOD OF PLAYING A BOARD GAME SIMULATING HORSE RACING AND WAGERING describes a board game that simulates the sport of horse racing and further allows players of the game to place wagers simulating on-track betting. The game includes a game board having a race course and infield, player position markers simulating racing horses, simulated money, betting tickets, chips, and chance and odds cards. The course is divided into a series of concentric tracks with each track being occupied by a corresponding marker during a race. Players place bets using the simulated money and receive betting tickets and chips according to their bets; the chips are placed in corresponding areas of an infield portion of the board. The player position markers are advanced according to or other chance determination, and moves are further modified in accordance with any chance cards which come into effect in the course of play. Odds cards may also change the odds during the course of the race. The first three markers are assigned win, place, and show positions and players win or lose according to their bets made prior to the race. Two or more players or teams may play, and provision is made to cause all player position markers to be played regardless of the number of actual players or teams. The game preferably comprises a series of races, with the player accruing the greatest winnings from his or her bets being the winner.

U.S. Pat. No. 5,795,226 issued to Yi on Aug. 18, 1998 for BETTING RACE GAME describes a device and method of playing a gaming game-simulating horse race which allows betting on a race already started. It comprises a playing surface with a race-course, means for displaying odds and results, means for generating random numbers to determine the progress of a race, means for self-service wagering, probability formulas and computer programs to calculate odds determined by the nature of a race and to display them, computer programs to calculate possible payoffs, and official results that can be displayed.

U.S. Pat. No. 5,839,726 issued to Luise on Nov. 24, 1998 for CASINO TABLE GAME describes a dice game having a horse-racing theme which includes a number of horses in the race, the number of which corresponds to the number of sides of a single die. In play, preferably three dice are used. When a number representing a horse is rolled by any of the dice, that horse is moved a distance referred to as a “furlong.” If the horse's number appears on more than one die in a single roll, then the horse is moved a comparable number of furlongs. The game provides for standard horse racing wagers on the eventual outcome of the race, such as win, place, and show. The game further provides for a series of wagers, referred to as “betting-in-running,” which can be placed on the outcome of each roll of the dice.

U.S. Pat. No. 5,853,173 issued to Murphy on Dec. 29, 1998 for NIGHT AT THE RACES BOARD GAME describes a playing board having a plurality of slots formed therein in an oval configuration. The plurality of slots forms a plurality of lanes. The plurality of slots is separated into twelve lengths. One of the twelve lengths signifies a starting point and a finishing point and being so indicated by indicia relative thereto. A plurality of playing pieces resembles a race horse. Each of the playing pieces is designated by a number. Each of the playing pieces has a flat lower portion adapted for positioning within the slots of the playing board. A plurality of action cards each details a move made by the plurality of playing pieces around the playing board.

One of the objects of the present invention is to provide a casino game that allows players to bet on simulated horse races.

Another of the objects of the present invention is to provide a casino game which provides chance means for the advance of the position markers, which position markers represent horses on a track.

Yet another of the objects of the present invention is to provide a casino game including means for betting or wagering on the outcome of the game.

An additional object of the present invention is to provide a casino game in which the number of players is variable.

With these and other objects in view which will more readily appear as the nature of the invention is better understood, the invention consists in the novel combination and arrangement of parts hereinafter more fully described, illustrated and claimed with reference being made to the attached drawings.

### SUMMARY OF THE INVENTION

The present invention is a casino game having a horse-racing theme. The casino game encompasses a number of playable races. A horseshoe playing surface is provided, which has a plurality of horse positions and a roulette-styled betting area inscribed thereon.

### BRIEF DESCRIPTION OF THE DRAWING

A complete understanding of the present invention may be obtained by reference to the accompanying drawing, when considered in conjunction with the subsequent detailed description, in which:

FIG. 1 is a schematic diagram of a horseshoe playing surface of the horseracing casino game in accordance with the present invention;

FIG. 2 is a schematic diagram showing horse positions;

FIG. 3 is an enlarged view of a roulette-styled betting area;

FIG. 4 is a schematic diagram of each horse betting spot available on both sides of the horseshoe playing surface area shown in FIG. 1; and

FIG. 5 is a perspective view of a chip loader unit used with the inventive casino game.

Similar reference characters denote corresponding features consistently throughout the several figures of the attached drawings.

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

In accordance with the invention, there is provided a casino game having a horse-racing theme. The casino game encompasses a number of playable races. In the preferred embodiment, the number of playable races is 84, but any number of races can be included in the game without departing from the scope of the invention.

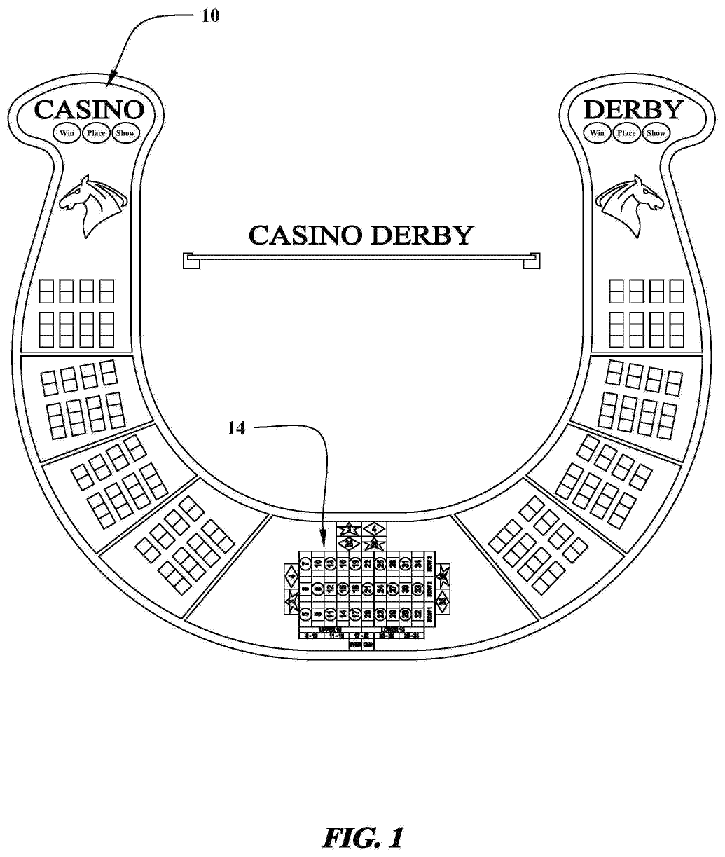

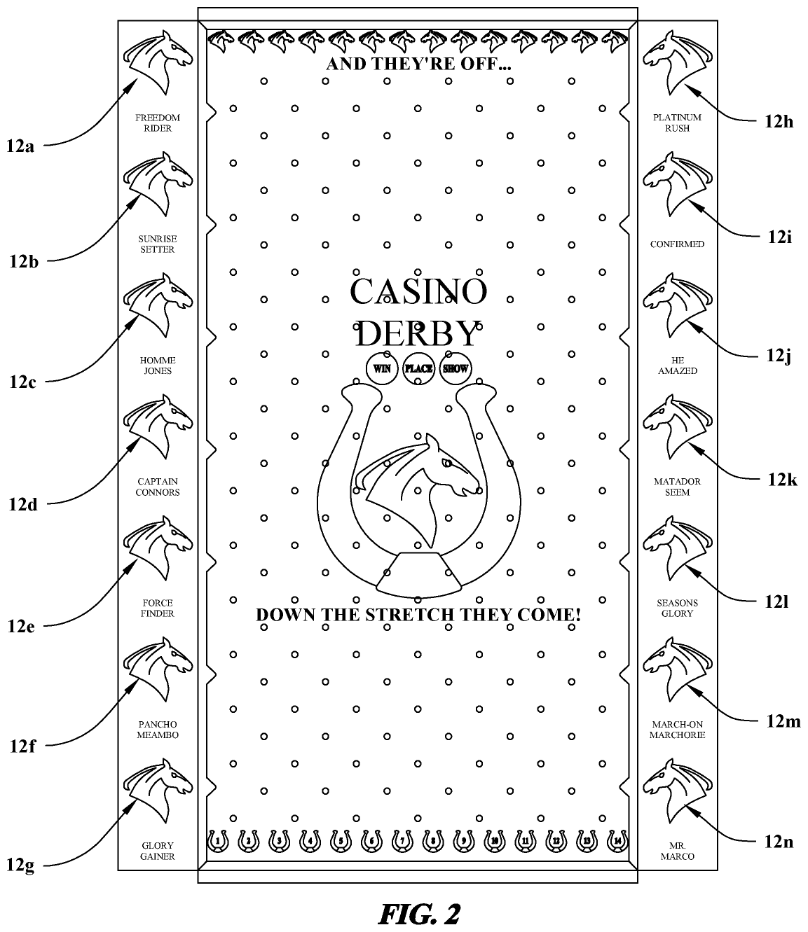

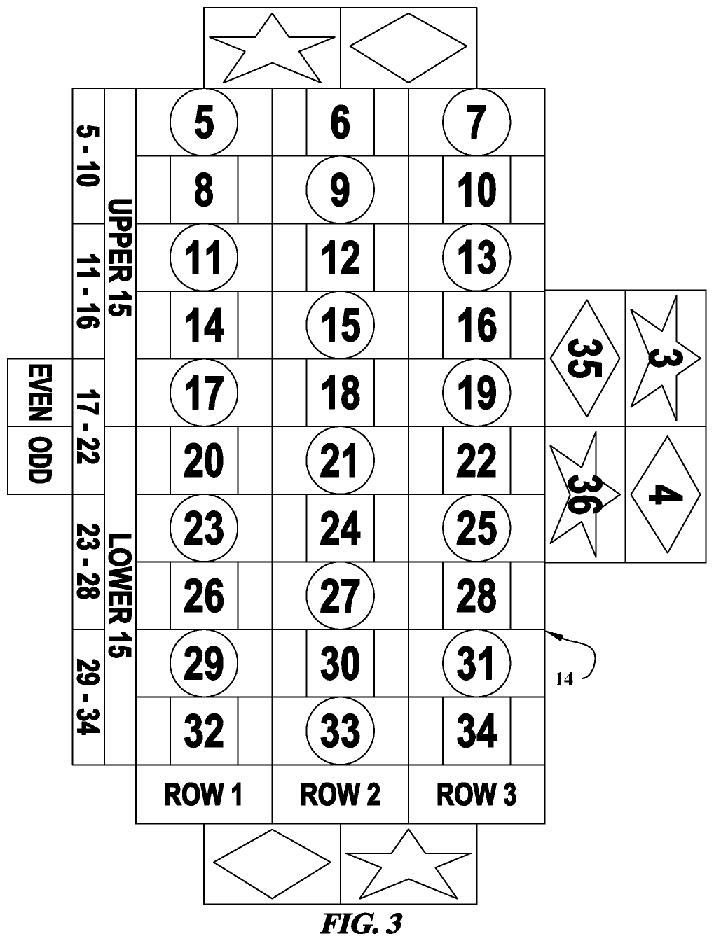

Referring now to FIGS. 1 and 2, there is shown a schematic diagram of a horseshoe playing surface of the horseracing casino game in accordance with the present invention. A horseshoe-shaped playing surface 10 is provided, having fourteen horse positions 12a-12n, in the preferred embodiment, and a roulette-styled betting area 14 for total sum betting, inscribed thereon. The dimensions of the playing surface are approximately 15′×10′. The roulette-styled betting area 14 is shown in enlarged detail in FIG. 3.

The game allows players to bet two ways:

1) on the horses; and

2) via roulette-styled total sum betting.

### Gameplay—The Horses

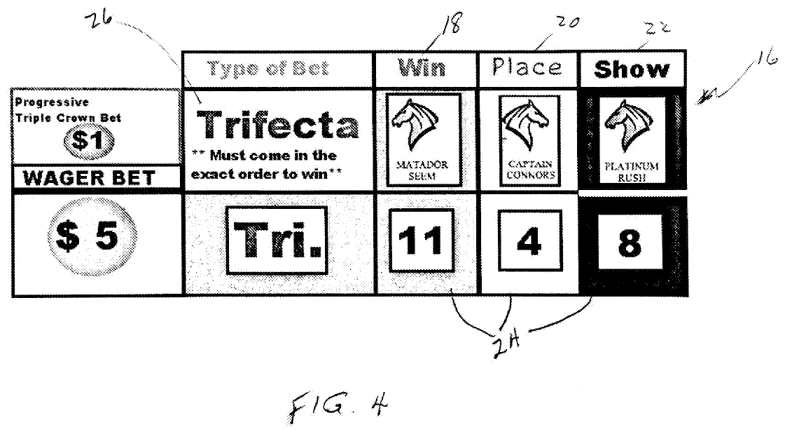

Referring now to FIG. 4, players can bet on fourteen different horses, in the preferred embodiment, by placing a chip or chips, not shown, in the horse betting spot 16 available on both side of the horseshoe surface playing area 10 in the following ways:

1) N=Normal Bet—Player wages for a horse to Win by placing a chip in the space provided 18, Place by placing a chip in the space provided 20, or Show by placing a chip in the space provided 22.

2) B2 or B3=Boxed (two) or (three)—Player bets on two or three horses by placing a chip or chips in the space(s) provided 24 to come in in any order but must pick the correct two or three in order to win.

3) Exta.=Exacta Bet—Player chooses a horse to Win and one to Place by placing chips in the respective spaces provided 24; the horses must come in the exact order.

4) Tri.=Trifecta—Player chooses three horses in the exact winning order by placing a chip in the spaces provided 24, 26.

### Gameplay—Total Sum Betting

Located in the center of the horseshoe-shaped table playing area 10 is the roulette-styled betting area 14 that provides an opportunity for players to win based on placing a chip in the respective space provided on the total sum of the three winning horse positions. The dimensions of the total sum area are 15″×6¾″.

### Example: Win=6; Place=5; Show=12. Total Sum=23

In the preferred embodiment, 84 different races can be run before the game repeats. The total sum betting feature includes a progressive total pot. That is, when one horse position wins three races in a row, the progressive total is shared among the winners or is won by the single player bet.

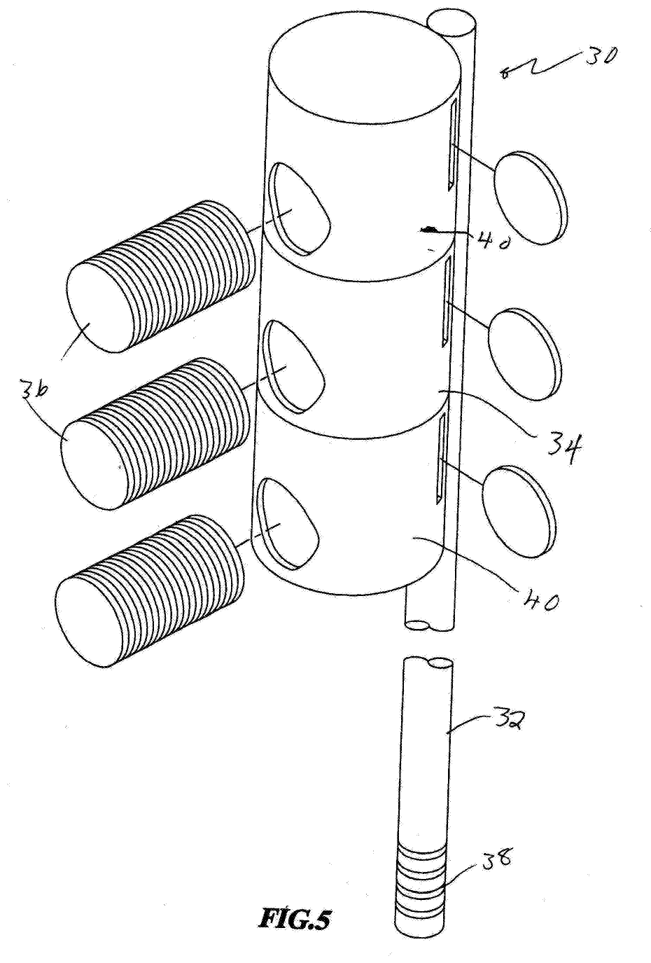

Referring now to FIG. 5, there is shown a chip loader unit 30. The unit 30 has a post or stand 32 in the preferred embodiment on which a housing 34 containing a stacked pile of chips 36 is rotatably mounted. The lower portion of post 32 has a friction grip 38 for a dealer, not shown, to grasp in order to move chip loader unit 30 into each release row on roulette-styled betting area 14 (FIG. 3).

Chips 36 are color coded, such that green chips represent WIN, yellow chips represent PLACE, and black chips represent SHOW. The WIN, PLACE, and SHOW chips 36 are stacked in corresponding sections 40 of housing 34.

In operation, a casino dealer lifts post 32, moves it to a predetermined row on roulette-styled betting area 14, and imparts a circular motion to housing 34, rotating housing 34 until friction slows and stops the motion and a WIN, PLACE, or SHOW chip 36 is released from housing and lands on a portion of roulette-styled betting area 14.

Since other modifications and changes varied to fit particular operating requirements and environments will be apparent to those skilled in the art, this invention is not considered limited to the example chosen for purposes of this disclosure, and covers all changes and modifications which does not constitute departures from the true spirit and scope of this invention.

Having thus described the invention, what is desired to be protected by Letters Patent is presented in the subsequently appended claim.

What is claimed is:

1. A casino game having a horse-racing theme, said casino game encompassing a plurality of playable races and comprising a horseshoe-shaped playing surface having a plurality of horse positions and a roulette-styled betting area inscribed thereon.

2. The casino game having a horse-racing theme in accordance with claim 1, wherein the casino game simulates a horserace.

3. The casino game having a horse-racing theme in accordance with claim 1, further comprising means for wagering.

4. The casino game having a horse-racing theme in accordance with claim 1, further comprising position markers representing horses on a track.

5. The casino game having a horse-racing theme in accordance with claim 1, further comprising a roulette-styled betting area.

6. The casino game having a horse-racing theme in accordance with claim 1, further comprising a chip loader unit.

7. The casino game having a horse-racing theme in accordance with claim 1, wherein the casino game comprises a plurality of playable races.

8. The casino game having a horse-racing theme in accordance with claim 4, wherein a player may bet on the horses represented by the respective position markers.

9. The casino game having a horse-racing theme in accordance with claim 1, wherein a player may bet via roulette-styled total sum betting.

10. The casino game having a horse-racing theme in accordance with claim 1, wherein players can bet on up to fourteen different horses, each of the horses having a unique horse position, in one horse racing game.
